(19) United States
(12) Patent Application Publication
(10) Pub. No.: US 2007/0122622 A1
(43) Pub. Date: May 31, 2007

(54) ELECTRONIC MODULE WITH THERMAL DISSIPATING SURFACE

(76) Inventor: Philip D. Freedman, Alexandria, VA (US)

Correspondence Address: PHILIP D FREEDMAN PC;PHILIP D FREEDMAN, 317 S. FAYETTE STREET, ALEXANDRIA, VA, 22314-5902, US

(21) Appl. No.: 11/627,961

(22) Filed: Jan. 27, 2007

Related U.S. Application Data
(63) Continuation-in-part of application No. 10/127,585, filed on Apr. 23, 2002.

(51) Int. Cl. B05D 5/12

(52) U.S. Cl. 428/408; 427/58

(57) ABSTRACT

An electronic module comprises: a thermal energy generating component; and a thermal dissipating surface comprising a thermal conductive substantially monolayer or single wall nanotube thermal conductive film in thermal conductive contact with the component.

### CROSS REFERENCE TO RELATED APPLICATION

This application is a continuation-in-part application of Freedman, Ser. No. 10/127,585, filed 23 Apr. 2002, now U.S. Pat. No. ______.

### BACKGROUND OF THE INVENTION

The invention relates to an electronic module with a thermal dissipating surface and to a method to produce an electronic module with a thermal dissipating surface.

Electronic components can generate large amounts of heat that can affect their operation. Particularly, components used in computer systems, generate large amounts of heat. For example, the following are some typical maximum central processing unit operating temperatures for various computer microprocessors: 1.3 GHz-69° C.; 1.4 GHz-70° C.; 1.5 GHz-72° C.; 256 or 512K L2 cache-85° C.; and 1 MB L2 cache-80° C. The component temperature must be maintained within the maximum operating temperature to optimize device performance and reliability. A component can fail if its temperature exceeds a maximum temperature.

A component can be kept within an operating temperature limit by transferring generated heat away from the component to ambient environment, usually the surrounding room air. The heat transfer can be accomplished for example, by associating a thermal dissipating surface with the component. A typical thermal dissipating surface comprises a structure, generally metal, that is thermal coupled to a heat source such as a microprocessor. The surface draws heat energy away from the heat source by conduction of the energy from a high-temperature region to the lower-temperature region. All modern microprocessors require a thermal dissipating surface.

Improved heat dissipation can be achieved by increasing the surface area of a thermal dissipating surface or by increasing fluid flow over the surface. One technique to improve efficiency of a conductive surface is to provide a greater surface area. However, increasing area typically involves increasing structure bulk, profile and weight.

As central processing unit components such as microprocessors and semiconductors become smaller, they run faster, do more and generate more heat. The heat dissipating challenge becomes more acute. Currently, there is a need for an improved heat dissipating surface that dissipates greater amounts of heat per unit size and for a method of producing such a structure within bulk, profile and weight constraints.

### BRIEF DESCRIPTION OF THE INVENTION

The invention provides a structure with a surface that dissipates the large amounts of heat per unit bulk, profile and weight necessary to cool modern day thermal energy generating components such as a microprocessor or semiconductor.

In an embodiment of the invention, an electronic module comprises: a thermal energy generating component; and a thermal dissipating surface comprising a thermal conductive substantially monolayer thermal conductive film in thermal conductive contact with the component.

In another embodiment, the invention is a method of producing an electronic module, comprising forming a thermal conductive, substantially monolayer film on a substrate and disposing the substrate in a heat dissipation relationship to or as part of a thermal energy generating component.

In another embodiment, the invention is an electronic module, comprising; a thermal energy generating component; and a thermal dissipating surface in thermal conductive contact with the component, the surface comprising a substrate with a thermal conductive upgraded SWNT coating or film.

In another embodiment, the invention is a method of producing an electronic module, comprising forming an upgraded SWNT product, applying the upgraded SWNT product to a substrate; and disposing the substrate in a heat dissipating relationship to or as part of a thermal energy generating component.

In still another embodiment, the invention is a method of producing an electronic module, comprising: forming a reaction product comprising fullerene including SWNT; heating the product under oxidizing conditions to produce an upgraded fullerene product comprising at least 80% SWNT; forming a coating of the SWNT composition on a substrate; and disposing the substrate in a heat dissipating relationship to or as part of a thermal energy generating component of an electronic module.

In still another embodiment, the invention is a microprocessor, comprising; a thermal energy generating component; and a thermal dissipating component in a heat dissipation relationship to or as part of the energy generating component, the thermal dissipating component comprising a substrate with a thermal conductive monolayer fullerene film.

In still another embodiment, the invention is a method of producing a microprocessor, comprising forming a thermal conductive, substantially monolayer film on a substrate and disposing the substrate in a heat dissipation relationship to or as part of a thermal energy generating component to form the microprocessor.

In still another embodiment, the invention is a microprocessor, comprising; a thermal energy generating component; and a thermal dissipating component in a heat dissipation relationship to or as part of the energy generating component, the thermal dissipating component comprising a substrate with a thermal conductive upgraded SWNT coating or film.

In another embodiment, the invention is a method of producing a microprocessor, comprising forming a thermal conductive, upgraded SWNT coating or film on a substrate and disposing the substrate in a heat dissipation relationship to or as part of a thermal energy generating component to form the microprocessor.

In another embodiment, the invention is a microprocessor, comprising; a thermal energy generating component; and a thermal dissipating component in a heat dissipation relationship to or as part of the energy generating component, the thermal dissipating component comprising a substrate with a thermal conductive aligned SWNT coating or film.

In another embodiment, the invention is a method of producing a microprocessor, comprising forming a thermal conductive aligned SWNT coating or film on a substrate and disposing the substrate in a heat dissipation relationship to or as part of a thermal energy generating component to form the microprocessor.

In another embodiment, the invention is an infrared sensor, comprising; a thermal energy generating component; and a thermal dissipating component in a heat dissipation relationship to or as part of the energy generating component, the thermal dissipating component comprising a substrate with a thermal conductive monolayer fullerene film.

In another embodiment, the invention is a method of producing an infrared sensor, comprising forming a thermal conductive monolayer fullerene film on a substrate and disposing the substrate in a heat dissipation relationship to or as part of a thermal energy generating component to form the infrared sensor.

In another embodiment, the invention is an infrared sensor, comprising; a thermal energy generating component; and a thermal dissipating component in a heat dissipation relationship to or as part of the energy generating component, the thermal dissipating component comprising a substrate with a thermal conductive upgraded SWNT coating or film.

In an embodiment of the invention, a method of producing an infrared sensor, comprises forming a thermal conductive upgraded SWNT coating or film on a substrate and disposing the substrate in a heat dissipation relationship to or as part of a thermal energy generating component to form the infrared sensor.

In an embodiment of the invention, an infrared sensor, comprises; a thermal energy generating component; and a thermal dissipating component in a heat dissipation relationship to or as part of the energy generating component, the thermal dissipating component comprising a substrate with a thermal conductive aligned SWNT coating or film.

In an embodiment of the invention, a method of producing an infrared sensor, comprises forming a thermal conductive aligned SWNT coating or film on a substrate and disposing the substrate in a heat dissipation relationship to or as part of a thermal energy generating component to form the infrared sensor.

In another embodiment, the invention is an electronic module, comprising; a thermal energy generating component; and a thermal dissipating surface in a thermal conductive contact with the component, the surface comprising a thermoplastic substrate with a thermal conductive monolayer fullerene film.

In another embodiment, the invention is a method of producing an electronic module, comprising forming a thermal conductive monolayer fullerene film a substrate and disposing the substrate in a heat dissipation relationship to or as part of a thermal energy generating component to form the electronic module.

In another embodiment, the invention is an electronic module, comprising; a thermal energy generating component; and a thermal dissipating surface in thermal conductive contact with the component, the surface comprising a thermoplastic substrate with a thermal conductive aligned SWNT coating or film.

In another embodiment, the invention is a method of producing an electronic module, comprising forming a thermal conductive aligned SWNT coating or film on a substrate and disposing the substrate in a heat dissipation relationship to or as part of a thermal energy generating component to form the electronic module.

In another embodiment, the invention is an electronic module, comprising; a thermal energy generating component; and a thermal dissipating surface in thermal conductive contact with the component, the surface comprising a thermoplastic substrate with a thermal conductive aligned SWNT coating or film.

In another embodiment, the invention is a method of producing an electronic module, comprising forming a thermal conductive aligned SWNT coating or film on a substrate and disposing the substrate in a heat dissipation relationship to or as part of a thermal energy generating component to form the electronic module.

In another embodiment, the invention is an electronic module, comprising; a thermal energy generating component; and a thermal dissipating surface in a thermal conductive contact with the component, the surface comprising a semiconductive or semiconductor substrate with a thermal conductive thermal conductive monolayer fullerene film.

In an embodiment of the invention, a method of producing an electronic module, comprising forming a thermal conductive thermal conductive monolayer fullerene film on a semiconductive or semiconductor substrate and disposing the substrate in a heat dissipation relationship to or as part of a thermal energy generating component to form the electronic module.

In an embodiment of the invention, an electronic module, comprises; a thermal energy generating component; and a thermal dissipating surface in thermal conductive contact with the component, the surface comprising a semiconductive or semiconductor substrate with an upgraded SWNT coating or film.

In an embodiment of the invention, a method of producing an electronic module, comprising forming a thermal conductive upgraded SWNT coating or film on a semiconductive or semiconductor substrate and disposing the substrate in a heat dissipation relationship to or as part of a thermal energy generating component to form the electronic module.

In an embodiment of the invention, an electronic module, comprises; a thermal energy generating component; and a thermal dissipating surface in thermal conductive contact with the component, the surface comprising a semiconductive or semiconductor substrate with a thermal conductive aligned SWNT coating or film.

In an embodiment of the invention, a method of producing an electronic module, comprises forming a thermal conductive thermal conductive aligned SWNT coating or film on a semiconductive or semiconductor substrate and disposing the substrate in a heat dissipation relationship to or as part of a thermal energy generating component to form the electronic module.

In an embodiment of the invention, an electronic module, comprises; a thermal energy generating component; and a thermal dissipating surface in thermal conductive contact with the component, the surface comprising a substrate that has a patterned SWNT coating or film forming a thermoelectric device.

In an embodiment of the invention, a method of producing an electronic module, comprises forming a patterned SWNT coating or film on substrate that is part of a thermoelectirc device and disposing the thermoelectric device in a heat dissipation relationship to or as part of a thermal energy generating component to form the electronic module.

In an embodiment of the invention, a method of producing an electronic module, comprises forming a thermal conductive fullerene coating on a first substrate; contacting a thermoplastic substrate with the fullerene surface of the first coating substrate to form a two substrate structure with intermediate fullerene coating between the substrates; applying a second fullerene coating to an exposed surface of the thermoplastic substrate by subliming a fullerene by heating to a temperature from about 450° C. to about 550° C. at a pressure less than about 1×10⁻⁸ torr. to produce a fullerene coating on the thermoplastic substrate; cleaving the intermediate fullerene coating between the two substrates to produce a fullerene coated thermoplastic substrate; and disposing the thermoplastic substrate in a heat dissipation relationship to or as part of a microprocessor.

### BRIEF DESCRIPTION OF THE DRAWINGS

FIG. 1 is a schematic representation of a substrate with a fullerene coating;

FIG. 2 is an exploded perspective view of a modular controller for operating an electric load such as a motor.

FIG. 3 is an exploded perspective view of central processing unit; and

FIG. 4 is an exploded perspective view of a microprocessor assembly.

### DETAILED DESCRIPTION OF THE INVENTION

According to the invention, a fullerene coated substrate provides a thermal dissipating structure that can have improved surface area, profile and fluid flow thermal transfer characteristics resulting in high efficiency. In this application, fullerene “coating” means a covering fullerene layer. The fullerene coating is a contiguous and substantially continuous coat or film or a pattern of coats or films spread onto a substrate.

Fullerene is a class of carbon molecule having an even number of carbon atoms arranged in the form of a closed hollow cage wherein the carbon-carbon bonds define a polyhedral structure reminiscent of a soccer ball. The most well studied fullerene is C₆₀, Buckminster fullerene. Other known fullerenes include C₇₀ and C₈₄. Also included is the fullerene nanotube, particularly a single wall nanotube (SWNT). A SWNT is hollow, tubular molecule consisting essentially of sp²-hybridized carbon atoms typically arranged in hexagons and pentagons. The SWNT can have a diameter in a range of about 0.5 nanometer (nm) to about 3.5 nm and a length that can be greater than about 50 nm.

A SWNT-containing fullerene product can be synthesized by an arc discharge process in the presence of a Group VIIIb transition metal anode, a laser ablation process, a high frequency plasma process, a thermal decomposition process (a chemical vapor deposition (CVD) process and a catalytic chemical vapor deposition (CCVD) process) wherein fullerene is sublimed at a controlled pressure and brought into contact with a heated catalyst, for example as disclosed by Maruyama P N 2006009345, incorporated herein by reference. These syntheses produce a distribution of fullerene reaction products including a SWNT distribution of diameters and conformations and amorphous and other carbon products including multi-wall carbon nanotubes and metallic catalyst residues. The distribution of reaction products varies depending on the process and process operating conditions.

The fullerene can be deposited on a substrate surface using a sputtering approach, by a sublimation technique, by spin coating or by any other suitable technique. In one method, a SWNT-containing fullerene coating can be applied onto a substrate by a solution evaporation technique using solutions of fullerene dissolved in non-polar organic solvents such as benzene, toluene, etc. These processes form a physisorbed coating. In other embodiments, the fullerene coating is applied to a substrate as the fullerene is formed, for example by sublimation as hereinafter described.

In an invention embodiment, a thermal dissipating surface comprises a thermal conductive, substantially monolayer film. As used herein, the term “monolayer” as applied to a film of fullerene means a coating having approximately one layer of fullerene molecules, although the properties of the coating may not be significantly affected if the film is slightly more than a molecule thick. Moreover, while a monolayer of fullerene molecules generally packs into a two-dimensional crystalline structure on the substrate, a fullerene coating with minor lattice defects in the monolayer may not alter the desirable properties of the fullerene layer and would be considered a monolayer. Hence in this application, “monolayer” or “monomolecular layer” means a substantially monomolecular thick layer that can include some molecular overlay and variation in diameter so that the thickness can vary from about 0.5 nm to about 6 nm. Preferably, the monolayer is less than 1 nm thick. In a desired embodiment, the monolayer is less than 1 nm thick to about 3 nm. The monolayer exhibits desirable and even in some instances, enhanced heat dissipating properties without adding significant structure or profile to a thermal energy generating component. In one embodiment, an electronic module comprises a thermal energy generating component; and a thermal dissipating surface in thermal conductive contact with the component, the surface comprising a substrate with a continuous SWNT film. In another embodiment, the substrate has a patterned SWNT coating or film that forms a thermoelectric device such as a Peltier device. These SWNT coatings, particularly the substantially monolayer thin films exhibit unique properties including high strength, stiffness and thermal and electrical conductivity.

The fullerene product of the above described syntheses includes only a proportion of SWNT product. An upgraded SWNT product having enhance thermal properties is desirable in some thermoelectric applications. Processes to obtain a fullerene product comprising an upgraded proportion of SWNT from a product of the above syntheses include contacting a fullerene product in the presence of a transition metal element or alloy under a reduced pressure in an inert gas atmosphere. Some direct processes for obtaining an upgraded SWNT product include catalytic laser irradiation, heat treatment and CCVD processes. For example, one SWNT product with less than about 10 wt % other carbon-containing species can be produced by an all-gas phase method using a gaseous transition metal catalyst and a high pressure CO as a carbon feedstock. However, catalyst residue can be left as an impurity in the product material.

Proportion of SWNT in a fullerene synthesis product can be enriched in accordance with certain other procedures to provide an improved and advantageous upgraded SWNT thermal coating and film. In one procedure, a SWNT-containing reaction product is heated under oxidizing conditions as described in Colbert et al. U.S. Pat. No. 7,115,864, incorporated herein by reference, to provide a product that is enriched in at least 80%, preferably at least 90%, more preferably at least 95% and most preferably over 99% SWNT. In the present application, an upgraded SWNT is a reaction product comprising at least 80% pure SWNT. The upgraded SWNT has been found to be particularly useful as a heat dissipating coating or film in combination with a thermal energy generating component.

In the Colbert et al. upgrade, a SWNT-containing product composition is heated in an aqueous solution of an inorganic oxidant, such as nitric acid, a mixture of hydrogen peroxide and sulfuric acid or potassium permanganate to remove amorphous carbon and other contaminants. The SWNT-containing synthesis product can be refluxed in an aqueous solution of the oxidizing acid at a concentration high enough to etch away the amorphous carbon deposits within a practical time frame, but not so high a concentration that the SWNT material will be etched to a significant degree. Nitric acid at concentrations from 2.0 to 2.6 M is suitable. At atmospheric pressure, the reflux temperature of the aqueous acid solution can be about 102° C.

In a preferred upgrade process, a SWNT-containing product can be refluxed in a nitric acid solution at a concentration of 2.6 M for 24 hours. The upgraded product can be separated from the oxidizing acid by filtration. Preferably, a second 24 hour period of refluxing in a fresh nitric solution of the same concentration can be employed followed by filtration. Refluxing under acidic oxidizing conditions may result in the esterification of some of the nanotubes, or nanotube contaminants. The contaminating ester material may be removed by saponification, for example, by using a sodium hydroxide solution in ethanol at room temperature for 12 hours. Other conditions suitable for saponification of ester linked polymers can be used. For example, saponification can be accomplished with a sodium hydroxide solution in ethanol at room temperature for 12 hours. The SWNT-containing product can be neutralized after the saponification step. Refluxing the SWNT-containing product in 6M aqueous hydrochloric acid for 12 hours is one suitable neutralization.

After oxidation, saponification and neutralization, the SWNT-containing product can be collected by settling or filtration to a thin mat form of purified bundles of SWNTs. In a typical example, the upgraded SWNT-containing product is filtered and neutralized to provide a black mat of upgraded SWNT about 100 microns thick. The SWNT in the mat may be of varying lengths and may comprise individual SWNTs and of up to 10³ SWNT bundles and mixtures of individual SWNTs of various thicknesses. A product that comprises nanotubes that are homogeneous in length, diameter and/or molecular structure can be recovered from the mat by fractionation. The upgraded SWNT can then be dried, for example by baking at 850° C. in a hydrogen gas atmosphere to produce a dry upgraded SWNT product.

According to one Colbert et al. procedure, an initial cleaning in HNO₃ can convert amorphous carbon in a SWNT product to various sizes of linked polycyclic compounds. The base solution ionizes most of the polycyclic compounds, making them more soluble in aqueous solution. Then, the SWNT mat product can be refluxed in HNO₃. The SWNT product can be filtered and washed with NaOH solution. Next, the filtered SWNT product is polished by stirring in a Sulfuric acid/Nitric acid solution. This step removes essentially all remaining material from the SWNT product that was produced during the nitric acid treatment. Then, the SWNT product is diluted and the product again filtered. The SWNT product is again washed with a NaOH solution.

Smalley et al. U.S. Pat. No. 6,183,713 incorporated herein by reference, discloses a method to make a SWNT reaction product by laser vaporizing a mixture of carbon and one or more Group VIII transition metals. Single-wall carbon nanotubes preferentially form in the vapor. The SWNT product is fixed in a high temperature zone where the Group VIII transition metal catalyzes further SWNT growth. In one Smalley et al. embodiment, two separate laser pulses are utilized with the second pulse timed to be absorbed by the vapor created by the first pulse. Colbert et al. subjected a Smalley et al. two laser method-produced SWNT product to refluxing in nitric acid, one solvent exchange, and saponification in saturated NaOH in ethanol. The product was neutralized and baked in a hydrogen gas atmosphere at 850° C. The procedure produced a >99% pure upgraded SWNT that can be applied to a substrate to form the upgraded SWNT film of the inventive thermal dissipating surface.

An aligned nanotube, particularly aligned SWNT coating or film is another desirable embodiment of the invention. Aligned carbon nanotube arrays can be synthesized in a hot filament plasma enhanced chemical vapor deposition (HF-PECVD) system. A variety of substrates (metal, glass, silicon, etc) are first coated with nickel nanoparticles and then introduced into the CVD chamber. The method of nickel nanoparticle deposition defines the nanotube site density. Standard aligned carbon nanotube arrays are produced on a nickel sputtering-coated substrate, whereas low site-density carbon nanotube arrays are produced on a nickel electric-chemical-coated substrate.

the fullerene can include a thermal transfer enhancing additive or dopant, for example encapsulation of one or more metal atoms encapsulated inside a fullerene “cage” or NT. Examples include Sc@C-82, Y@C-82, La@C-82, Gd@C-82, La-2@C-80, Sc-2@C-84 and alkali metal, Fe, Cr and Ni and silicon-doped fullerene film and NT.

The substrate can be a semiconductor such as silicon, or a material or a metal such as aluminum, copper or alloy thereof. An aluminum sheet is a preferred substrate because of its advantageous mechanical and heat transmitting characteristics. In general, pure aluminum has better thermal conductivity than an alloy. However, aluminum alloy is preferred because of its better mechanical characteristics.

While fullerene heat conductivity is 0.4 W/mk at 300° K, the heat transmission of the fullerene coating or film can be has high as 6000 watts per meter per Kelvin at room temperature, even without dopant, additive or SWNT upgrading. The thermal conductivity of the SWNT has a nearly linear temperature dependence over an entire measured temperature range. At all temperatures, the magnitude of the thermal conductivity indicates that it is dominated by phonons. The room-temperature thermal conductivity can exceed diamond or in-plan graphite. The fullerene coating of the invention is so remarkably heat transmissive that it permits the use of substrate materials that can be chosen for characteristics and properties other than heat conductibility. Hence according to one aspect of the invention, the substrate can be a thermal non-conducting or insulating material. In this instance, a substrate material can be selected for its structural properties. Hence, the substrate can be a steel that is selected because it is a desirable construction material. Other suitable substrate materials include polymers and plastics such as polystyrenes and polyurethanes, which may be attractive because of their light weight or polyvinyl chlorides, which otherwise would be unsuitable because of thermal instability. Other suitable substrate materials include polycarbonates and polymethacrylates, which may be visually desirable or attractive. Even polyethylene and polypropylene films may be selected as suitable because of their lightweight and/or flexibility. Film substrates with applied SWNT film are particularly useful in flexible applications, for example some organic light emitting diode applications.

Contact between the heat dissipating film or coat and the substrate for example a microprocessor or infrared sensing surface, is important to effective dissipation. The surfaces of the device and the microprocessor or infrared module are never entirely flat. An interface between a directly applied fullerene and the microprocessor, infrared sensor or integral surface thereof will have tiny air gaps. Since air conducts heat poorly, these gaps can have a very negative affect on the heat transfer. Use of a monolayer fullerene or SWNT film overcomes this problem by filling in substantially all gaps to provide a highly effective heat transfer with substantially no increase in surface structure or profile. A fullerene or SWNT film applied in a substantially monolayer thickness provides a direct molecular scale interface contact between dissipater and thermal energy generator.

These and other features will become apparent from the drawings and following detailed discussion, which by way of example without limitation describe preferred embodiments of the invention. In the drawings, corresponding reference characters indicate corresponding parts throughout the several figures.

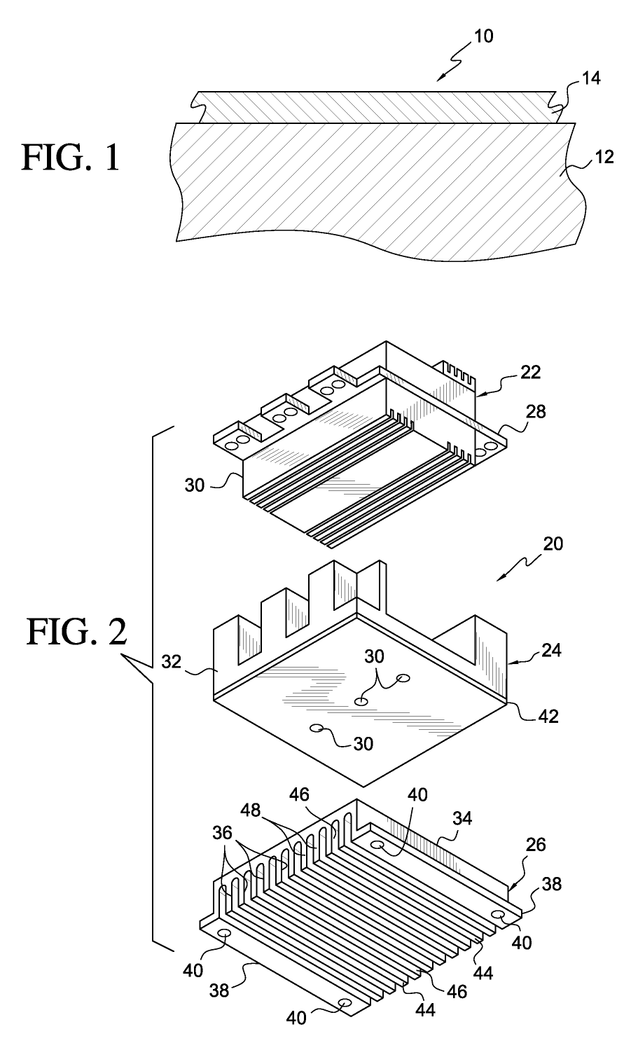

FIG. 1 shows a thermal dissipating surface 10 comprising a substrate 12 with a fullerene coating 14. The coating 14 can be applied by any suitable method. In a preferred embodiment, the fullerene coating is applied by sublimation. In one process, the fullerene is sublimed from a powder by heating to a temperature greater than about 450° C. under low pressures, preferably less than about 1×10⁻⁶ torr. The preferred sublimation temperatures are from about 450° C. to about 550° C. in one process, the fullerene powder is heated to a first lower temperature, preferably from about 200° C. to about 350° C. to remove any solvent or other impurities. In this process. The sublimation step can be conducted at less of a reduced pressure but at a higher temperature. However, it is preferred that the sublimation step is conducted at lower pressure, preferably less than about 1×10⁻⁸ torr.

In the process, the fullerene powder is placed in a porous container or tube and the substrate is placed at the tube or container opposite end. The substrate surface is protected while the powder is brought to sublimation temperature and pressure. When the sublimation pressure and temperature are reached, the substrate surface is exposed while maintained at a lower temperature. The sublimed fullerene vapor condenses onto the substrate surface and forms to the substrate surface material. In an embodiment, the substrate is swept past the fullerene powder source at a rate to provide desired condensation and coating. Exposure time and sublimation conditions can be controlled to provide a desired fullerene coating thickness on the substrate surface.

In another embodiment, the fullerene coating is deposited by sublimation from a solution. In this process, fullerene is dissolved in toluene and the resulting solution is loaded into a resistively heated stainless steel tube oven. The oven is placed into a vacuum chamber, which is evacuated to approximately 10⁻⁶ Torr. The oven is then heated to about 150° C. for five minutes. A substrate is rotated above the tube oven opening. The tube is then further heated to at least 450° C., preferably to approximately 550° C. to sublime the fullerene from the solvent onto the substrate surface.

Suitable vacuum chambers for the sublimation include ultrahigh vacuum chambers operating at pressures of no more than about 1×10⁻⁷ torr. However, to minimize contamination, it is desirable to conduct the sublimation process in a vacuum chamber operating at a pressure less than about 1×10⁻⁸ torr and preferably in a chamber that operates at less than about 1×10⁻¹⁰ torr.

In some applications, a thin monolayer fullerene film may be desirable to provide an effective heat dissipating structure without changing device properties and without adding significant device weight or profile. In these applications, a thin, even monolayer can be applied according to one or more procedures. In one procedure, the monolayer coating is formed by depositing a coating of fullerene molecules onto the substrate and removing layers of the coating to produce a residual layer of desired thickness. The layers are removed by selectively breaking fullerene-to-fullerene intermolecular bonds without breaking the fullerene-to-substrate association or bonding and without subjecting the coating or substrate to injurious temperatures.

Fullerenes strongly bond to a substrate surface. Indeed, the fullerenes bond to a metal/semiconductor substrate surface is stronger than inter molecular bonding among fullerene molecules. Excess fullerenes beyond a desired thickness such as a monolayer can be thus selectively removed by heating to a temperature sufficient to break the fullerene-fullerene bonds without disrupting the fullerene monolayer.

Desorption temperature is related to bond strength among fullerene molecules or between fullerenes and substrate. Hence, strength of fullerene bonding can be estimated by the temperature at which the fullerenes desorb. For multilayer fullerene molecules on a substrate, fullerene desorption temperature is between 225° C. and 300° C. Hence, an applied temperature of higher than 225° C., desirably at least 350° C. and in some applications up to about 450° C. will affect fullerene desorption without disrupting the fullerene to substrate bond. In one process, desorption of excess fullerene beyond a monolayer can be achieved by heating at a temperature from about 225° C. to about 300° C.

Other methods of selectively breaking the fullerene intermolecular bond include laser beam, ion beam and electron beam selective irradiation. For example, an energetic photon laser beam, electron beam or inert ion beam can be irradiated to the coated fullerene with a controlled energy that is sufficient to break fullerene-to-fullerene intermolecular bonds without breaking fullerene-to-substrate associations or bonds. The parameters of the beam irradiation depend upon the energy, flux and duration of the beam and also depend on the angle of the beam to the fullerene coating. In general, the energy of irradiation is controlled to avoid fullerene molecule decomposition or reaction and to avoid excessive local heating. For example, it is preferred to operate a laser at an energy outside of the ultraviolet range preferably in the visible or infrared range, to avoid reacting fullerene molecules. On the other hand, the laser can be effectively operated in the ultraviolet range to cleave fullerene layers so long as operating conditions such as temperature, pressure and pulsation are controlled. In a preferred embodiment, the laser or other light source is operated in the visible or infrared portion of the spectrum. Light intensity and beam size can be adjusted to produce the desired desorption rate of fullerenes beyond a desired layer thickness such as a monolayer thickness.

In ion beam irradiation, a beam is generated by bombarding a molecular flow with high energy electrons that produce ionization. The ion beam can be directed with electrodes. If an ion beam is used, beam energy and flux should be low enough to avoid decomposing the fullerene or forming higher-ordered fullerene molecules. For example, acceleration voltage can be as high as 3.0 kilovolts for some applications. Desirably, the voltage is between 50 and 1000, and preferably between about 100 and 300 volts. The beam current density can be in the range of about 0.05 to 5.0 mA/cm² (milliAmperes per square centimeter).

If a gas cluster ion beam is employed, ion clusters can be used that have an atomic mass approximating that of the fullerene molecules. A C₆₀ fullerene molecule has an atomic mass unit (AMU) of 720. Beams of clustered ions approximating the mass of the fullerene molecules can be used to inject energy into the multilayer fullerene coating to break the fullerene-to-fullerene intermolecular bond without depreciating the fullerene molecules. Clusters can be formed by expanding an inert gas such as argon, through a supersonic nozzle followed by applying an electron beam or electric arc to form clusters.

The angle of incidence of a directed beam to the fullerene coating can be varied to control cleavage of dissociation. In one embodiment, a beam angle relative to irradiated target can be selected between about 25° and about 75°, preferably between 40° and 65°. When ion beam irradiation is used, incident angle is determined by balancing factors such as removal efficiency and precision.

Oxidation of a metal or semiconductor substrate surface can substantially reduce bonding strength and effectivenss of the fullerene coating. Metal surfaces are particularly susceptible to oxidation; hence a metal substrate surface should be cleaned prior to applying the fullerene coating. Surface cleaning can be by Ar⁺ sputtering at about 0.1 to about 10 keV, by electron bombardment or by polishing. The substrate can be annealed by heating following cleaning to ensure a smooth uniform surface. A polishing step should be selected to avoid the introduction of other contaminants. For example, ceramic particles without a solvent or with a nonaqueous solvent are suitable polishing compositions.

In one embodiment, a clean substrate is assured by both cleaning the substrate and applying the fullerene coating within the same common controlled environment. The controlled environment can be a vacuum chamber such as an ultrahigh vacuum chamber where gaseous impurities are eliminated by operating at low pressures. In other types of air-tight chambers, impurities can be eliminated by purging with an inert gas, such as argon. The gas should be substantially free from water vapor and oxygen. Suitable chambers are available commercially for adaptation to the present process. If a sublimation step is used to form the initial fullerene coating, the fullerene layers can be cleaved to a desired thickness in the same vacuum chamber where the substrate surface is cleaned and the fullerene coating is deposited. Maintaining the substrate under vacuum keeps it clean and reduces beam scattering during irradiation. Additionally the vacuum can prevent fullerene recondensation by removing desorbed fullerene from the irradiation area.

In one aspect of the invention, it has been found that fullerene coatings can be applied to certain substrates that would otherwise be damaged by the conditions of coating application. For example, fullerenes cannot be applied to certain lower melting substrates that would otherwise be damage because of the high temperature requirements for fullerene sublimation. According to this embodiment of the invention, a method of applying a fullerene coating to a substrate that melts at a temperature lower than the application temperature of the fullerene coating (lower melting substrate) comprises first applying a fullerene coating to a first higher melting temperature substrate (melting at a temperature higher than the application temperature of the coating) to produce a first fullerene coated substrate. The first fullerene coated substrate is placed in contact with a lower melting temperature substrate with a first surface in contact with an exposed fullerene surface of the fullerene coated substrate to form a two substrate structure with intermediate fullerene coating between the substrates. A second fullerene coating is then applied to an exposed surface of the second substrate and the intermediate fullerene coating between the two substrates is cleaved to produce two fullerene coated substrates, one of which is the lower melting temperature substrate. The intermediate fullerene coating functions to dissipate heat away from the lower melting structure while the second coating is applied at a temperature that otherwise could damage the lower melting substrate.

Fullerenes are commercially available from SES Research, Houston, Tex. Alternatively, there are well known ways of synthesizing fullerenes. For example, arc heating of graphite in an inert atmosphere, such as 150 torr He, results in carbon clusters from which fullerenes can be extracted with hot toluene. Fullerenes can be further purified by column chromatography of organic dispersions of fullerenes, such as with silica or alumna columns, to produce purified fullerenes.

Once the coatings are completed, the substrates can be removed from the controlled environment. The fullerene coated substrates are then used as thermal dissipating surfaces in various applications. FIGS. 2 to 4 show thermal energy generating components 22, 52 and 82 in thermal conductive contact with respective fullerene thermal dissipating surfaces 26, 70 and 86. The thermal dissipating surface 26, 70 and 86 of the invention comprises the fullerene formed as an interconnected and continuous coating or film on a substrate surface to provide a heat conductive path from the thermal energy generating component to ambient.

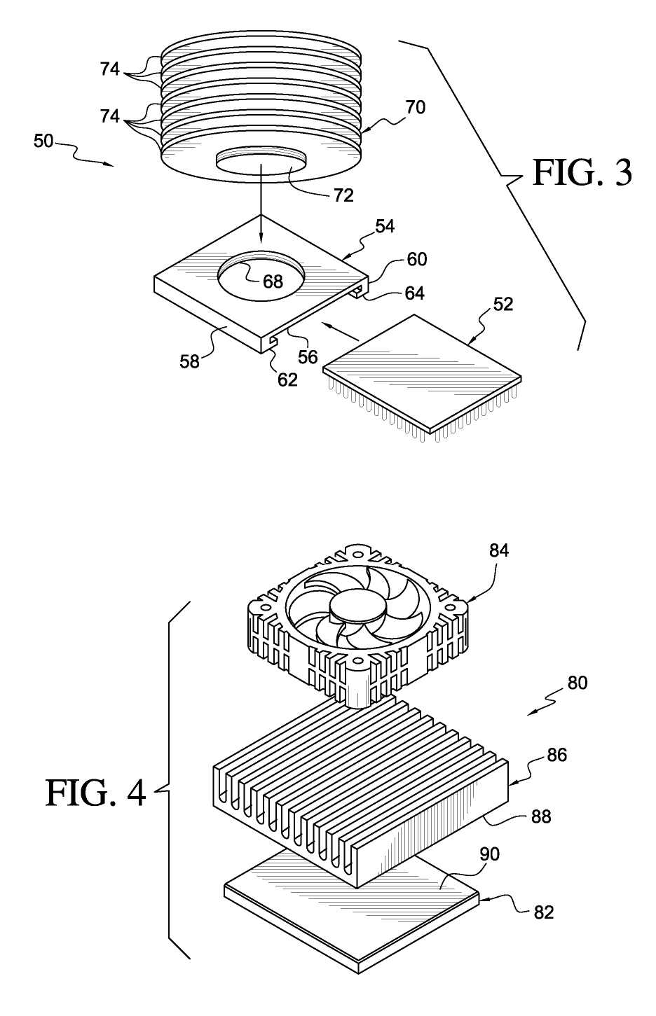

FIG. 2 shows a modular controller 20 for operating an electric load such as a motor, FIG. 3 shows a central processing unit 50 and FIG. 4 shows a microprocessor assembly 80. In FIG. 2, modular controller 20 comprises a control logic module 22, electrical power switching assembly 24 and a heat dissipating surface, which is heat sink 26. The module 22 includes an electronic circuit (not shown) for controlling the operation of an electric motor. The module comprises an electrically insulating enclosure 28 with a rectangular lower portion 30. Power switching assembly 24 comprises switching modules 32 positioned side by side beneath the control logic module 22 to control electric power for a motor. The assembly 24 also includes contact plate 42 extending along the assembly 24 bottom surface. The assembly 24 includes apertures 30 through contact plate 42 for receiving connectors (not shown) for fastening to heat sink 26.

Heat sink 26 can be formed of an underlying heavy gauge metal having a high thermal capacity or according to one embodiment of the invention, the heat sink 26 is formed from a structural material that has little or no thermal capacity. The heat sink 26 can be in any suitable heat dissipating configuration. In FIG. 2, the heat sink 26 has a flat base 34 with a plurality of extending fins 36. The heat sink 26 has a flange 38 with apertures 40 for mounting the heat sink 26 and the entire modular motor controller 20 with an electrical control panel.

The contact plate 42 provides an interface between switching assembly 24 and heat sink 26. The contact plate surface can be fullerene coated as shown in FIG. 1, to provide improved heat dissipation from the switching assembly 44. The heat sink fins 36 provide extending surfaces to dissipate heat away from the switching assembly 24. Each fin 36 comprises a lateral surface 44, extending surfaces 46 and end surface 48. The fin surfaces 44, 46 and 48 provide air contact for increased heat exchange. In various embodiments, the contact plate 42, a fin lateral surface 44, fin extending surface 46, fin end surface 48 or combinations thereof are fullerene coated as shown in FIG. 1 to provide improved heat dissipation. A thermal grease or similar material can be applied at the interface of the switch module contact plate 42 and the heat sink 26 to provide improved thermal conductivity. In other embodiments, the thermal grease is eliminated and a contact plate 42 is provided with a fullerene coating or is in direct or close contact with a heat sink fullerene coated surface to provide improved thermal dissipation.

FIG. 3 shows another thermal energy generating component and thermal dissipating surface combination. In this embodiment, central processing unit 50 comprises a printed circuit board 52, an adapter 54 and a thermal dissipating surface 70. The adapter 54 is formed of an electrically insulative material, such as an ABS plastic. The adapter 54 has depending top wall 56 and opposed side walls 58, 60. Side walls 58, 60 are formed with laterally inwardly extending lips 62, 64. The lips 62, 64 form a groove with top wall 56 adapted to capture outer extremities or marginal portions of a solid state device such as printed circuit board 52.

The printed circuit board 52 is inserted into adapter 54 with outer marginal portions received between lips 62, 64 so that its central portion is aligned with threaded bore 68 and in contact with a threaded central insert 72 of heat sink 70. The threaded central insert 72 of heat sink 70 is screwed into threaded bore 68 until it bottoms out against the printed circuit board 52. In this embodiment, the heat sink 70 is a passive device that acts like a radiator to conduct heat away from the printed circuit board 52.

In the FIG. 3 embodiment, heat sink 70 is formed of a structural material. The sink 70 comprises a plurality of thin members 74 extending integrally from a core having threaded insert 72 adapted to be threadingly received in threaded bore 68. Thermal conductivity is imparted to the heat sink 72 by a fullerene coating that is applied to a surface of the thin members 74, to a surface of the insert 72, to a surface of the threaded bore 68 to combinations of surfaces of the thin members, insert or adapter 12. Again, a thermal conductive grease, such as a silicon based grease or a flexible heat conductive tape can be applied between insert 72 and printed circuit board 52 to further enhance heat dissipation.

The FIG. 4 microprocessor assembly 80 comprises a printed circuit board 82, a fan 84 and fullerene coated heat sink 86. The heat sink 86 sits on the top of the printed circuit board 82 and has fins between which air can pass. The bottom 88 of the heat sink 86 is of a flat surface so that the heat sink 86 can be in close contact with the top 90 of printed circuit board 82. Any or all of the fins can be fullerene coated as shown in FIG. 1 in accordance with the invention. The fan 84 is screwed or otherwise secured on the top of the heat sink 86. The printed circuit board 82 is mounted in contact with the heat sink 86 and electrically connected to a service device, which can be a computer, processor, controller or the like.

As depicted in the figures, each thermal dissipating surface 26, 70, 86 is in thermal contact with respective thermal energy generating component 22, 52, and 82 but is not part of or integral with the thermal energy generating component 20. Rather the thermal dissipating surface 26, 70, 86 is a separate structural unit. Each thermal dissipating surface 26, 70, 86 is in a heat dissipating relationship adjacent the microprocessor to dissipate heat away from the microprocessor eventually to the ambient. The thermal dissipating surface 26, 70, 86 is not “integral” to a thermal energy generating microprocessor, where “integral” means existing as an essential constituent of the microprocessor or constituting an undiminished entirety of the microprocessor. A thermal dissipating surface 26, 70, 86 of the invention would not work to dissipate heat to the ambient if an integral of a thermal dissipating surface.

In general, large motors or high speed microprocessors require larger heat sinks 26, 70, 86 to dissipate increased heat generated by larger components. The improved heat dissipating capacity imparted by the fullerene coating means that motor size of the size of any heat generating structure can be increased without requiring an enlarged associated heat sink. The applied fullerene coating, which can be applied in a layer as thin as a single molecule, i.e., one nanometer, adds no significant bulk to the combined structure.

The invention provides a nominal weight, size and thickness structure that imparts exceptional thermal transfer and heat dissipation to a heat generating module.

While preferred embodiments of the invention have been described, the present invention is capable of variation and modification and therefore should not be limited to the precise details of the Examples. The invention includes changes and alterations that fall within the purview of the following claims.

1. An electronic module, comprising;
a thermal energy generating component; and
a thermal dissipating surface comprising a thermal conductive substantially monolayer thermal conductive film in thermal conductive contact with the component.

2. The electronic module of claim 1, wherein the substantially monolayer film is 0.5 nm to about 6 nm thick.

3. The electronic module of claim 1, wherein the substantially monolayer film is less than 1 nm to about 3 nm thick.

4. The electronic module of claim 1, wherein the substantially monolayer film is one nanometer or less thick.

5. The electronic module of claim 1, wherein the thermal conductive substantially monolayer film comprises fullerene.

6. The electronic module of claim 1, wherein the thermal conductive monolayer film comprises a carbon nanotube.

7. The electronic module of claim 1, wherein the thermal conductive monolayer film comprises SWNT.

8. The electronic module of claim 1, wherein the thermal conductive monolayer film comprises an upgraded SWNT.

9. (canceled)

10. The electronic module of claim 1, wherein the thermal conductive monolayer film comprises at least 90% SWNT.

11. The electronic module of claim 1, wherein the thermal conductive monolayer film comprises at least 95% SWNT.

12. (canceled)

13. The electronic module of claim 1, wherein the thermal conductive monolayer film comprises substantially aligned SWNT.

14. The electronic module of claim 1, wherein the thermal conductive monolayer film comprises nanotubes that are substantially homogeneous in length, diameter or molecular structure.

15 to 31. (canceled)

32. A method of producing an electronic module, comprising forming a thermal conductive, substantially monolayer film on a substrate and disposing the substrate in a heat dissipation relationship to or as part of a thermal energy generating component.

33-49. (canceled)

50. An electronic module comprising;
a thermal energy generating component; and
a thermal dissipating surface in thermal conductive contact with the component, the surface comprising a substrate with a thermal conductive upgraded SWNT coating or film.

51. The electronic module of claim 50, wherein the surface comprises a substrate with an aligned thermal conductive upgraded SWNT coating or film.

52. (canceled)

53. (canceled)

54. The electronic module of claim 50, wherein the thermal conductive upgraded SWNT comprises at least 90% SWNT.

55. (canceled)

56. The electronic module of claim 50, wherein the thermal conductive upgraded SWNT comprises at least 99% SWNT.

57. The electronic module of claim 50, wherein the thermal conductive upgraded SWNT comprises substantially aligned SWNT.

58. The electronic module of claim 1, wherein the thermal conductive monolayer film comprises nanotubes that are substantially homogeneous in length, diameter or molecular structure.

59-75. (canceled)

76. A method of producing an electronic module, comprising forming an upgraded SWNT product, applying the upgraded SWNT product to a substrate; and disposing the substrate in a heat dissipating relationship to or as part of a thermal energy generating component.

77-122. (canceled)
